(19) United States
(12) Patent Application Publication
(10) Pub. No.: US 2015/0337793 A1
(43) Pub. Date: Nov. 26, 2015

(54) COMBUSTION IGNITION SYSTEM

(71) Applicant: Contour Hardening, Inc., Indianapolis, IN (US)

(72) Inventors: John M. Storm, Danville, IN (US); Donald L. A. Smith, II, Avon, IN (US)

(21) Appl. No.: 14/818,463

(22) Filed: Aug. 5, 2015

Related U.S. Application Data
(63) Continuation of application No. PCT/US2013/027945, filed on Feb. 27, 2013.
(60) Provisional application No. 61/763,234, filed on Feb. 11, 2013.

(51) Int. Cl. F02P 19/02; F02B 75/02

(52) U.S. Cl. CPC F02P 19/022; F02B 75/02; F02P 19/02; F02P 19/025; F02B 2075/025

(57) ABSTRACT

Ignition systems, devices, and methods of using a resistive heating element to initiate combustion in internal combustion engines are disclosed. In one embodiment, an ignition system comprises a conductive member having a portion arranged for positioning within a combustion chamber of an internal combustion engine and comprising at least two high-resistance portions separated by a low-resistance portion, the high-resistance portions arranged to reach a temperature sufficient to cause ignition within the engine. In some instances, a conductive member positioned within a combustion chamber and arranged to ignite an air/fuel mixture comprises an inner portion and an outer portion, the inner portion comprising a heat removing portion arranged to remove heat from the outer portion sufficient to prevent pre-ignition. Other embodiments are disclosed.

### CROSS-REFERENCE TO RELATED APPLICATION

This application is a continuation of International Patent Application No. PCT/US2013/027945 filed Feb. 27, 2013 which claims the benefit of provisional U.S. Patent Application No. 61/763,234, filed on Feb. 11, 2013 which is hereby incorporated by reference in its entirety.

### FIELD OF THE INVENTION

The present invention relates to the field of ignition sources and more particularly to ignition sources used in internal combustion engines.

### BACKGROUND

In the field of internal combustion engines, especially the reciprocating type, a measured quantity of fuel and air is compressed and ignited either by an ignition source or by the heat of compression. The engine in which the air/fuel mixture is ignited by the heat of compression is commonly called a diesel engine. It utilizes a system where the air for combustion is compressed to an elevated temperature sufficiently high to ignite the fuel supplied from a fuel injection source. Such fuel injection source is typically an injector having a tip exposed to the combustion chamber and which sprays fuel in discrete streams. The fuel injector injects the fuel either in a radiating pattern from a central location or in a given direction to promote mixing by swirl of the combustion chamber air. However, in either case, the injection of fuel and the resultant initiation of combustion is begun substantially at or adjacent a point of maximum piston travel.

Developments in the field of homogenous charge compression ignition engines have proposed injecting fuel into the intake air prior to compression and using various schemes to ignite the resultant mixture. Such proposal usually involves a point ignition source such as a sparkplug.

By far the most common engine type on the road is the spark ignited gasoline engine. The gasoline engine was first developed in the latter part of the 19^{th} Century and has since been employed widely for powering passenger vehicles owing to its relatively quiet operation and starting ease. With the advent of increasing energy prices and customer demand, the spark ignition engine is being asked to do significantly more than it was in prior years. Gasoline engine developments have, for the most part, focused on carrying a maximum flow of air efficiently into the combustion chamber and exhausting the products of combustion after the combustion event occurs. Developments like multiple valves, tuned intake systems, variable geometry intake systems, and positive charging of the intake charge by a turbocharger or supercharger are common approaches used to try to improve air flow.

Correspondingly, the fuel system has evolved and developed through the use of injectors. The injectors have been electronically controlled to vary the quantity and timing to produce highly flexible injection of fuel into the mixture for combustion. Additional proposals have been made for electromechanically injecting fuel directly into the combustion chamber similar to a system mechanically implemented on early Mercedes Benz sports cars.

Recently, biofuels have been proposed that use various forms of ethanol or methanol from grain crops, cellulous fiber or vegetable matter thereby providing a renewable resource. Such fuels offer the advantage of high octane ratings so that higher compression ratios may be easily handled within the combustion chamber. They also permit a significant reduction in emissions. However, one drawback with fuels of this type is the slow propagation of the flame front making it necessary for ignition timing to be well in advance of top dead center (TDC) to be sure all of the mixture is combusted timely. This early ignition in turn reduces efficiency as the combustion pushes in one direction against the piston that is moving in the opposite direction as it moves toward TDC.

The sparkplug is a common igniter used to initiate combustion of a fuel air mixture in a spark ignition engine. Various developments over the years have increased the energy passing across the spark gap so that it more efficiently promotes combustion. In addition, some inventors have suggested enhancing the ignition by subjecting the spark gap to electromagnetic forces to, in effect, widen the area over which combustion is initiated.

However, most of these approaches still suffer from the limitation that they require high voltages to generate sparks, which have associated concerns about safety, radio frequency interference, reliability, electrical insulation, and requirements for high voltage generation equipment and switching. In 1946, his U.S. Pat. No. 2,403,290 to Korman outlined many of the limitations to spark plugs. This patent discloses a sparkplug replacement—an ultra-high frequency ignition device that either used a single wire or a thin conducting film on an insulating support powered by an ultra-high frequency ignition generator to heat to the ignition temperature. Korman's single heated wire or conductive film coated insulator incorporated desirable “skin effect” surface heating, but Korman's disclosure had unappreciated shortcomings as to its design, implementation and application, seriously limiting its usefulness. Another problem exists related to diesel engines and their inability to start in cold weather. As noted above, a diesel engine utilizes the heat of compression to ignite the air/fuel mixture in the combustion chamber. However, when the cylinder head and cylinder block are cold, they serve as a heat sink, absorbing a portion of the heat generated by the compression. Currently, glow plugs are utilized to heat the engine block and surrounding cylinders. Because glow plugs are essentially resistive loads that emit heat when a current is run through them, the pre-heating process can take some time: up to 20 seconds. Therefore, there exists a need for quicker and more efficient heating sufficient to allow ignition for diesel engines in cold weather conditions.

### SUMMARY

In electrical conductors, high-frequency electrical current tends to be distributed such that the current density is greatest near the surface of the conductor, referred to as the “skin effect”. The depth at which much of the current flows (i.e., the “skin depth”) can be approximated by the following equation:

$$δ = \sqrt{\frac{2 ρ}{ω μ}} \qquad ( 1 )$$

where
ρ is the resistivity of the conductor
ω is the angular frequency of current (2π×frequency)
μ is the absolute magnetic permeability of the conductor (which can be found by μ=μ₀·μᵣ; where μ₀ is the permeability of free space and μᵣ is the relative permeability of the material).
   The concentration of current at the surface of the conductor can result in the rapid heating of the surface of the conductor, without a comparably rapid heating of its interior. Additionally, particularly in materials that exhibit the skin effect most prominently, the effective resistance of the conductor is substantially greater at higher frequencies due to the decreased effective cross-sectional area of the conductor.

Some embodiments of this disclosure teach devices and methods using the localized heating of a conductor associated to the skin effect to ignite an air/fuel mixture in an internal combustion engine. Alternatively, or additionally, the present disclosure teaches devices and methods for preheating a combustion chamber so that compression of air and/or an air/fuel mixture within the chamber will reach a temperature sufficient to cause ignition. In some embodiments, the present disclosure provides arrangements in which a conductive member has a relatively low electrical resistivity and a relatively high magnetic permeability.

Additionally, in some instances, the present disclosure describes an ignition system for an internal combustion engine that can produce a heat source that is unrestrained by conventional single point ignition principles. The ignition system can comprise a conductive member with multiple separate, discrete heating portions that increase the skin effect in those portions and thereby effectively provide multiple simultaneous heat sources. The portions can be arrayed within the combustion chamber so as to permit multiple flame fronts to propagate from multiple ignition sources or locations within the chamber. Advantageously, this can allow for combustion of fuel within the combustion chamber in a shorter period of time than conventional single point ignition systems, allowing for ignition to occur closer to top dead center, resulting in improved efficiency.

In some embodiments, the present disclosure provides an ignition apparatus for an internal combustion engine, comprising an electrical power supply, a conductive member having a portion arranged for positioning inside a combustion chamber of the internal combustion engine and comprising at least two high-resistance portions separated by a low-resistance portion; and the conductive member electrically connected to the electrical power supply through a conductor. In some instances, at least one of the high-resistance portions comprises a section of the conductive member having a minimum outer dimension less than that of the low-resistance portion. Additionally or alternatively, in some embodiments the electrical power supply is configured and arranged to supply electrical power at a frequency above 100 kHz. Preferably, the frequency is below 200 MHz.

The present disclosure also teaches an internal combustion engine arranged to combust an air/fuel mixture comprising a conductive member having a portion positioned inside a combustion chamber of the internal combustion engine, arranged to provide ignition of the air/fuel mixture, and comprising an inner portion and an outer portion; an electrical power supply configured and arranged to periodically provide electrical power, at a frequency below 200 MHz in some instances, to the conductive member portion sufficient to raise the temperature of the outer portion above the ignition temperature of the air/fuel mixture; the inner portion comprising a heat removing portion thermally coupled to said outer portion and arranged to remove heat from the outer portion. In some instances, the internal combustion engine is a two-cycle engine and in some instances the fuel has an ignition point above 400° C. The fuel is preferably natural gas. Additionally, or alternatively, the conductive member can be configured and arranged to cool the outer portion at least 80° C. in less than 40 milliseconds and more preferably in less than 20 milliseconds, and most preferably in less than 10 milliseconds.

In some embodiments, the present disclosure provides an internal combustion engine comprising an electrical power supply; a first conductive member and a second conductive member each comprising at least two high-resistance portions located within the same cylinder of the internal combustion engine; the high-resistance portions of the first and second conductive members separated by low-resistance portions; and the conductive members conductively connected to the electrical power supply. In some instances, the first and second conductive members are separately insertable and removable from the engine without removing the head of the engine. Additionally or alternatively, the conductive members are recessed within the head of the combustion chamber.

Further forms, objects, features, aspects, benefits, advantages, and embodiments of the present invention will become apparent from a detailed description and drawings provided herewith.

### BRIEF DESCRIPTION OF THE DRAWINGS

FIG. 1 illustrates a schematic view of an exemplary ignition system in an engine.

FIG. 2 illustrates a perspective view of one embodiment of a conductive member.

FIG. 3 illustrates a perspective view of the conductive member embodiment of FIG. 2 with mounts and connectors.

FIG. 4 illustrates a perspective view of one arrangement of mounting the conductive member of FIGS. 2 and 3 in a head.

FIG. 5 illustrates a cross sectional view of one embodiment of mounting a conductive member within a cylinder of an internal combustion engine.

FIG. 6 illustrates a cross sectional view of another embodiment of mounting a conductive member within a cylinder of an internal combustion engine.

FIG. 7 illustrates a sectional view of the head of the FIG. 6 taken along line 7-7.

FIG. 8 illustrates a cross sectional view of another embodiment of mounting a conductive member within a cylinder of an internal combustion engine.

FIG. 9 illustrates a sectional view of the head of the FIG. 8 taken along line 9-9.

FIG. 10 illustrates a front elevational view of a portion of one embodiment of a conductive member.

FIG. 11 illustrates a cross sectional view of one embodiment of a conductive member.

FIG. 12 is a flowchart illustrating a system for controlling an ignition system.

### DESCRIPTION OF THE ILLUSTRATED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

The disclosed embodiments and variations thereof may be used to ignite a fuel mixture within a cylinder of an internal combustion engine. Some portions will discuss exemplary arrangements and/or methods with specific reference to particular engines, such as two-cycle or four-cycle diesel or spark ignition engines; however, it is not intended that the present disclosure be limited to such.

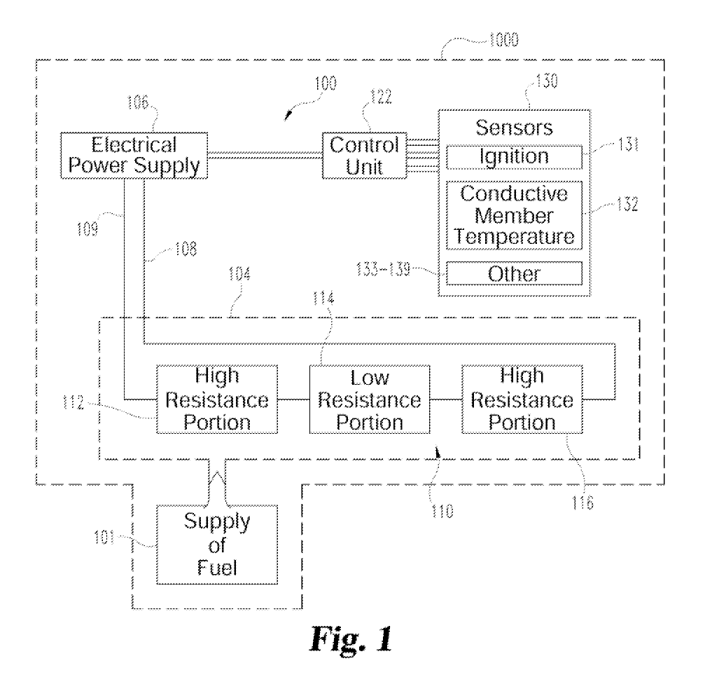

FIG. 1 illustrates a schematic view of an ignition system 100 of an internal combustion engine 1000, the ignition system 100 having an interior portion 104 positioned within a combustion chamber of the internal combustion engine 1000.

The ignition system includes an electrical power supply 106 that may be configured to deliver electrical energy in the form of alternating current (AC) or direct current pulses (DC) to interior portion 104 through electrical conductors 108, 109. Electrical power supply 106 is controlled by control unit 122 which responds to sensors 130, and can thus be arranged to provide AC or DC electrical energy at a frequency, voltage, and current sufficient to heat a portion of internal portion 104 to a temperature above the combustion temperature of the air/fuel mixture within the combustion chamber so as to cause ignition. Sensors 130 include suitable sensors as may be needed or desired for inputs to the control system (see also FIG. 12 hereafter), which may include for examples, but not limited to—a crank angle sensor, piston position sensor, coolant temperature, fuel temperature, fuel pressure, fuel flow rate, knocking sensor, combustion sensor, air temperature, air pressure, vehicle speed, vehicle acceleration, mass air flow, oxygen concentration, camshaft angle, power supply voltage, power supply current, power supply frequency, throttle position, fuel type, fuel injector status, etc. In some instances, sensors 130 can include ignition sensor 131 for detecting ignition of the air/fuel mixture within the combustion chamber, conductive member temperature sensor 132 for measuring the temperature of the conductive member (discussed below), and/or other sensors 133-139.

In some instances, interior portion 104 comprises a conductive member 110 that has a portion arranged to resistively heat to a temperature above the combustion temperature of the air/fuel mixture within the combustion chamber so as to ignite the air/fuel mixture and thereafter to rapidly cool to a temperature below the combustion temperature so as to prevent pre-ignition during the following cycle. As will be described below, conductive member 110 may comprise any of a number of arrangements. In some instances, conductive member 110 comprises a first high-resistance portion 112 and a second high-resistance portion 116 separated by a low-resistance portion 114. Alternatively or additionally, conductive member 110 can comprise an inner portion and an outer portion, wherein the inner portion comprises a thermal conductor.

As will be appreciated, ignition system 100 and the embodiments disclosed below may be used with a variety of different types of internal combustion engines 1000. For example, ignition system 100 may be used in two-cycle and four-cycle engines with any number of cylinders. Similarly, ignition system 100 may be used in both reciprocating and nonreciprocating engines. For example, ignition system 100 can be used in a Wankel (a.k.a. “rotary”) engine.

Advantageously, ignition system 100 may be used to ignite a variety of fuels. Internal combustion engines found in automobiles commonly burn gasoline, diesel, or E85 (an ethanol and gasoline blend). Ignition system 100 is suitable not only for these fuels but also for fuels having a much high ignition temperature. For example, ignition system 100 may be used to ignite ethanol, propane, and/or natural gas from a supply of fuel 101. The ignition temperatures for these fuels when used with air in an internal combustion engine can be found below in Table 1.

TABLE 1
Ignition Temperatures of Fuels

| | | | | | Compressed |
|---|---|---|---|---|---|
| | | | | | Natural Gas |
| | Diesel | Gasoline | Ethanol | Propane | (CNG) |
| Ignition Point | 316 | 257 | 424 | 449 | 538 |
| (° C.) | | | | | |

Generally internal combustion engines operate more efficiently with higher compression ratios. However, where the fuel is introduced prior to near the top of the compression stroke, higher compression engines run the risk of preignition. Thus, the use of fuels with higher ignition points allows for higher compression ratios for designs that introduce the fuel to the air before nearing the top of the compression stroke. Such systems with higher ignition point fuels can thus be simpler and more efficient—avoiding the “knocking” problem of undesirable preignition that reduces efficiency and engine life. Applicant's invention is remarkably suitable for use with such high ignition point fuels, with correspondingly optimized engine designs. With internal combustion engines that introduce the fuel near the top of the compression stroke, issues can arise as to whether the fuel suitably admixes with the air prior to or during combustion.

Unlike spark ignition systems, ignition system 100 does not require the use of high voltage components, such as ignition coils which have associated concerns about safety, radio frequency interference, reliability, electrical insulation, and requirements for high voltage generation equipment and switching. In contrast, ignition system 100 can simply operate with voltages significantly less than 30 kilovolts, with minimal risks of safety, radio frequency interference, reliability, electrical insulation. For example, in some instances, ignition system 100 operates with about 50 volts. The lower operating voltage of ignition system 100 also aids in eliminating RF noise that can interfere with other electronic components associated with an engine and the health risks to those operating on high-voltage ignition systems. Electrical power supply 106 is configured and arranged to periodically supply electrical power to the inner portion 104, such as conductive member 110, through electrical conductors 108 and/or 109. In several embodiments, electrical power supply 106 is configured and arranged to periodically supply electrical power at a frequency above 100 kHz. Additionally, in some instances, electrical power supply 106 supplies electrical power at a frequency below 200 MHz.

Electrical power supply 106 can be arranged to supply alternating current (AC), direct current (DC), or both. For example, electrical power supply 106 can be arranged to supply a plurality of DC pulses at a frequency above 100 kHz with a duty cycle of 50%. As will be appreciated, an electrical power supply 106 can be arranged to provide a particular frequency, voltage, and/or current or a range of frequencies, voltages, and/or currents. Electrical power supplies 106 that provide DC can be further arranged to provide a particular duty cycle or range of duty cycles.

Electrical conductors 108, 109 can be any conductor apparent to one of ordinary skill in the art to be suitable for transmission of high frequency electrical power. For example, electrical conductors 108, 109 can be coaxial transmission lines made of a commonly used electrically conductive material, such as copper. In some instances, existing portions of an engine or vehicle, such as the engine block or head, may serve as one of electrical conductors 108, 109. Resistive heating has also been found to have several benefits over spark ignition.

Resistive heating elements degrade differently than spark plugs and do not create harmful coronas that and accelerate degradation of various materials. Additionally, resistive heating elements can associate multiple high-resistance portions with a single conductor connected to an electrical power supply whereas engines having multiple spark plugs per cylinder require multiple high-voltage leads and/or ignition coils. Similarly, with multiple high-resistance portions on a single resistive heating element, multiple ignition points may be positioned within the cylinder through a single opening in the cylinder wall whereas systems using more than one spark plug usually require multiple openings in the cylinder wall to receive the plugs.

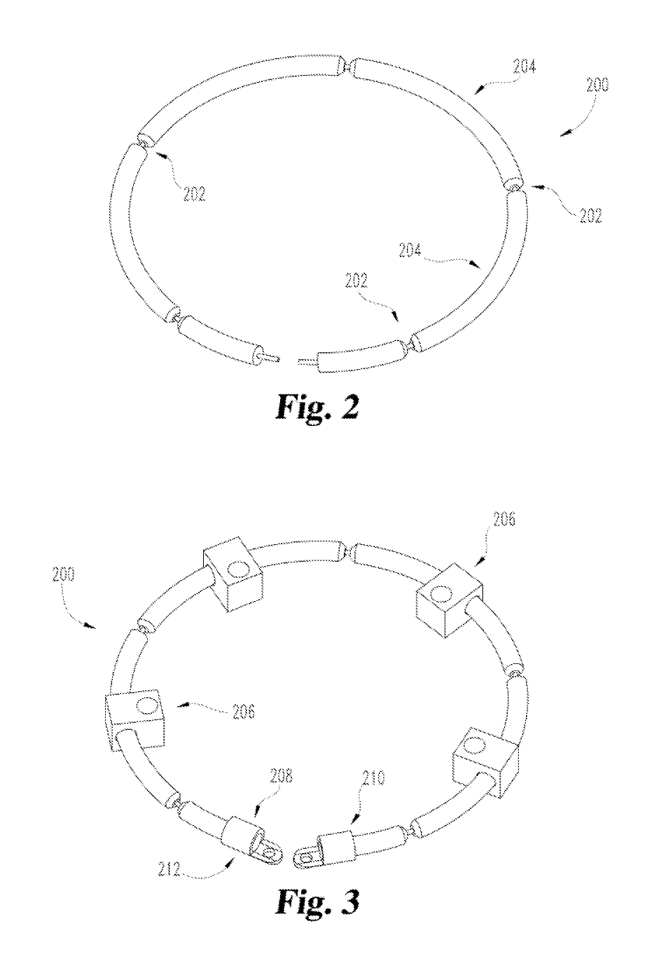

FIG. 2 illustrates an exemplary conductive member 200 comprising a plurality of high-resistance portions 202 separated by low-resistance portions 204. In some instances, one or more low-resistance portions 204 are positioned between two or more high-resistance portions 202. As illustrated in FIG. 2, the high-resistance 202 and low-resistance 204 portions can be connected in series. However, as will be appreciated by one of ordinary skill in the art, one or more low-resistance portions 204 may connect two or more high-resistance portions 202 in parallel. Advantageously, connecting at least two high-resistance portions 202 in parallel can provide a failure resistant device allowing for the failure of a high-resistance portion 202 with at least one other high-resistance portion 202 maintaining electrical continuity through the conductive member 200. In some instances, at least one high-resistance portion 202 is connected in series with a second high-resistance portion and in parallel with a third high-resistance portion.

In some instances, conductive member 200 comprises at least two high-resistance portions 202 separated by at least one low-resistance portion 204. In some embodiments, conductive member 200 comprises four or more high-resistance portions 202 each separated by a low resistance portion 204. Additionally, high-resistance portions 202 may spaced along the length of conductive member 200 or positioned along only a portion of conductive member 200. For example, in some arrangements, high-resistance portions 202 may be evenly spaced or spread apart along a length of conductive member 200. In other embodiments, a high-resistance portion 202 may be closer to one high-resistance portion 202 and further from another. In some instances, the lengths of low-resistance portions 204 can vary so as to space high-resistance portions 202 unevenly along a length of conductive member 200.

As will be appreciated, conductive member 200 may form any of a variety of shapes. As illustrated in FIG. 2, conductive member can form a generally circular arrangement with high-resistance portions 202 positioned along the periphery. However, it is contemplated that conductive member 200 can be formed into other shapes such as a linear, polygon, or a curvilinear shape, just to name a few non-limiting examples. Additionally, high-resistance portions 202 may be positioned along, within, or both along and within the periphery of the area defined by conductive member 200.

FIG. 3 illustrates an exemplary conductive member 200 with one or more mounts 206 and connectors 208. The mounts 206 can be arranged to attach one or more portions of conductive member 200 to a surface within the cylinder of an internal combustion engine. For example, mounts 206 can be arranged to mount low-resistance portions 204 to the deck of the head. In some embodiments, mounts 206 substantially surround portions of conductive member 200, such as low-resistance portions 204. It is preferred that mounts 206 are electrical insulators and resist the flow of electrical current from the conductive member 200 into the engine block, or vice versa, through a mount 206.

Mounts 206 can also be arranged to be thermally conductive. For example, mounts 206 may comprise a material with a high thermal conductivity and/or be arranged to transfer heat from conductive member 200 to the engine block. However, it is also contemplated that mounts 206 can comprise a thermal insulator, such as a ceramic, so as to resist the transfer of heat between conductive member 200 and the engine block.

In some instances, at least one connector 208 is coupled to conductive member 200. For example, as illustrated in FIG. 3, conductive member 200 may have first end 210 and second end 212 with one or more connectors 208 positioned thereon. Connectors 208 can be arranged to electrically couple conductive member 200 to other portions of ignition system 100, such as electrical conductors 108, 109 that connect to an electrical power supply.

Connectors 208 can be of any type that one of ordinary skill in the art would understand to be suitable. In some instances, first and second ends 210, 212 of conductive member 200 are connectable to electrical conductors 108, 109 through a single connector 208. For example, connector 208 can resemble a spark plug with a post providing a connection to electrical conductor 108 and a threaded portion providing a connection to electrical conductor 109 (e.g., the engine block).

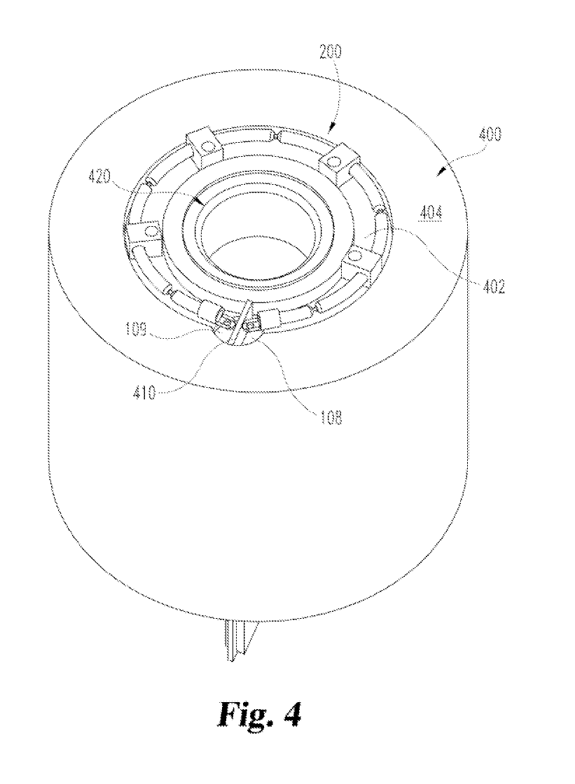

FIG. 4 illustrates one embodiment of conductive member 200 of FIGS. 2 and 3 positioned on the head 400 of engine 1000. In some instances, conductive member 200 is positionable within a recess 402 defined by the deck 404. Connectors 208 couple ends 210 and 212 of conductive member 200 to electrical conductors 108 and 109 which extend to a location outside of the cylinder. In some embodiments, electrical conductors 108 and 109 are separated by an insulating element 410 that prevents electricity from passing between electrical conductors 108 and 109. Similarly, electrical conductors 108 and 109 may be individually insulated and/or positioned in a coaxial arrangement. As can be seen from the illustration in FIG. 4, conductive member 200, mounts 206, and/or connectors 208 can be arranged to reside within recess 402 such that portions of conductive member 200, mounts 206, and/or connectors 208 do not extend beyond the deck 404.

As will be appreciated, conductive member 200 and the associated components (e.g., mounts 206 and connectors 208) may be positioned within a number of different engine configurations. For example, conductive member 200 may be positioned within two-cycle and/or four-cycle engines. Conductive member 200 may also be positioned within engines having various valve arrangements. For example, conductive member 200 may used in engines having overhead valve openings, side valve openings (e.g., flathead engines), and/or in engines in which the valve openings are positioned within the lateral walls of the cylinder, such as a sleeve valve or valve openings that are covered and exposed by the piston, just to name a few non-limiting examples.

In some instances, head 400 defines a valve opening 420 arranged to receive a valve, such as an exhaust or intake valve, that allows for the selective opening and closing of one end of the cylinder. Additionally, in some embodiments, recess 402 and/or conductive member 200 are arranged to extend around a portion of valve opening 420. For example, as illustrated in FIG. 4, recess 402 and conductive member 200 may extend around valve opening 420.

Advantageously, conductive member 200 can position high-resistance portions 202 across a wide area of the head. This allows for the propagation of multiple flame fronts across deck 404 of head 400 which can lead to a quicker combustion of the air/fuel mixture within the cylinder. Unlike current ignition timing systems, such as spark ignition systems that cause the spark to occur well in advance of top dead center (TDC), the quicker combustion of the air/fuel mixture by ignition system 100 (including conductive member 200) allows for combustion to be initiated closer to top dead center, therefore increasing efficiency.

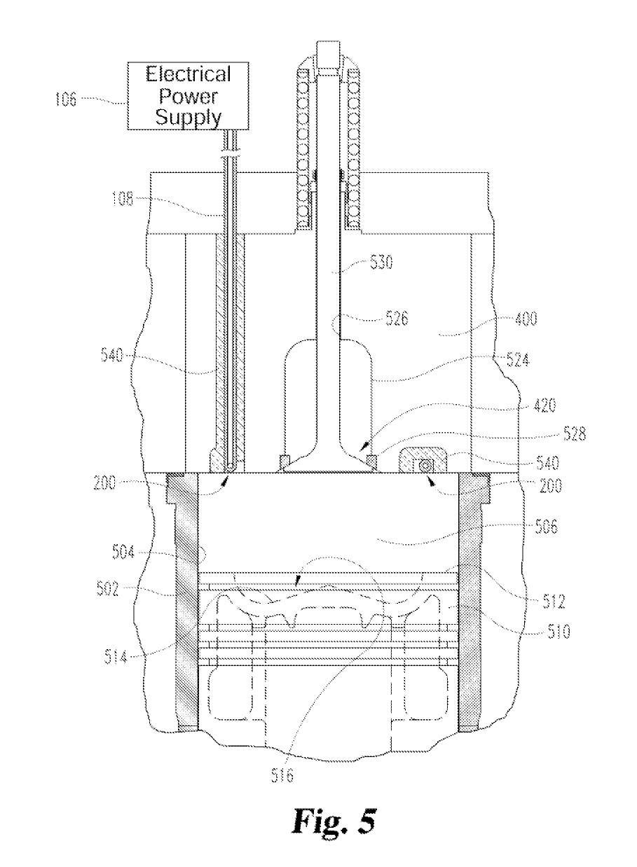

FIG. 5 illustrates a portion of an internal combustion engine comprising cylinder wall 502 having an inner surface 504 that defines combustion chamber 506. A piston 510 is positioned within combustion chamber 506 and has a piston face 512 facing upwards, towards combustion chamber 506 and closing the bottom end of the cylindrical combustion chamber 506.

Closing the top end of combustion chamber 506 is cylinder head 400. Cylinder head 400 comprises deck 404 that faces combustion chamber 506 and, in some instances, defines valve opening 420 which is fluidly connected to an inlet/exhaust runner 524. Inlet/Exhaust runner 524 and valve opening 420 are arranged to allow for air/fuel mixture to flow into combustion chamber 506 and/or for exhaust gasses to flow from combustion chamber 506. Cylinder head 400 also defines valve guide 526 and valve seat 528 arranged to receive a poppet valve 530 for the selective opening and closing of valve opening 420 for the intake of air/fuel mixture and/or exhaust of gasses from combustion chamber 506.

In some instances, piston face 510 has a contour 514. Contour 514 an be arranged to promote the swirling and/or mixing of the air/fuel mixture positioned with combustion chamber 506 so as to promote the combustion of all fuel within combustion chamber 506. Additionally, or alternatively, contour 514 can be arranged so as to promote scavenging (e.g., the exhaust of) spent air/fuel mixture.

In some instances, contour 514 of piston face 510 defines a recess 516. Recess 516 may be arranged to receive portions of valve 530 and/or to alter the flow of air/fuel mixture and/or gasses within combustion chamber 506. In some embodiments, recess 516 is arranged to receive portions of interior portion 504 of ignition system 100, such as conductive member 510, as will be discussed in more detail below.

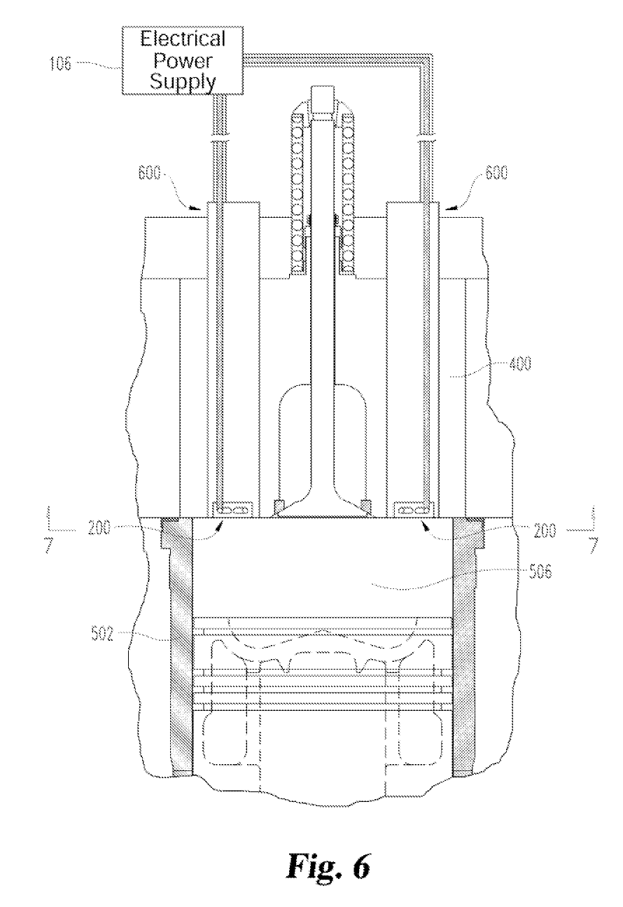

As can be seen in FIGS. 5 and 6, ignition system 100 comprises electrical power supply 106 preferably positioned external of combustion chamber 506 with electrical conductors 108 and 109 (not shown) electrically connecting electrical power supply 106 to interior portion 104 positioned within combustion chamber 506. In some instances, electrical conductors 108 and/or 109 extend through portions of cylinder head 400. For example, electrical conductors 108 and/or 109 can extend through the inlet/exhaust runner 524 and/or through a dedicated cavity in cylinder head 400. In some arrangements, electrical conductors 108 and/or 109 can extend through cylinder wall 502. Additionally or alternatively, portions of the engine block, such as head 400, may serve as one of electrical conductors 108, 109.

At least one of electrical conductors 108, 109 is surrounded by an insulator 540 so as to electrically insulate electrical conductor(s) 108, 109 from another electrical conductor and from surrounding materials. Similarly, interior portion 104 of the ignition system 100, such as the conductive member 110, 200, may have an insulator 540 that separates interior portion 104 from cylinder head 400 and/or cylinder wall 502, such as mounts 206.

In FIG. 5, the interior portion 104 of ignition system 100, such as conductive member 200, is retained within a recess defined by a deck 404 of cylinder head 400, such as in FIG. 4 above. High-resistance portions 202 and low-resistance portion 204 positioned within recess 402 defined by deck 504 of cylinder head 400 communicates with combustion chamber 506. In this arrangement, upon application of electrical energy to internal portion 104, the outer surface of high-resistance portions 202 can heat to a temperature above the combustion temperature of the air/fuel mixture in combustion chamber 506 so as to cause ignition.

FIG. 6 illustrates another embodiment of an ignition system 100 for an internal combustion engine. As illustrated, one or more insertable members 600 may extend through head 400 and/or cylinder wall 502 into combustion chamber 506. A conductive member such as conductive member 200 can be positioned on the portion of insertable members 600 exposed to combustion chamber 506 so that when an air/fuel mixture is compressed within combustion chamber 506, portions of conductive member 200 can be selectively heated so as to ignite air/fuel mixture in contact therewith and generate a flame kernel for propagation through combustion chamber 506.

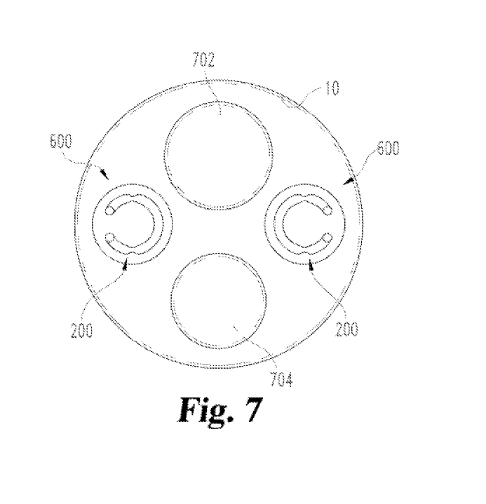

In some embodiments, insertable members 600 are insertable through head 400 similar to how spark plugs are insertable into engines using spark ignition, so as to allow for removal and servicing without removal of head 400. For example, each insertable member 600 may have a threaded outer surface mateable with a threaded surface of head 400. As will be appreciated, insertable members 600 may extend towards combustion chamber 506 from any number of positions or angles so as to avoid other necessary components of the engine, such as inlet or exhaust valves. FIG. 7 illustrates a bottom view of head 400 as viewed along line 7-7 of FIG. 6. As can be seen, insertable members 600 are spaced apart on head 400 and within combustion chamber 506. In engines having an intake valve 702 and/or an exhaust valve 704 in head 400, conductive members 200 of insertable members 600 can be positioned in portions of head 400 remote from the valve openings. As will be appreciated, one or more insertable members 600 may be inserted into combustion chamber 506, and each insertable member 600 may have a conductive member such as conductive member 200 having a plurality of high-resistance portions 202 separated by one or more low-resistance portions 204.

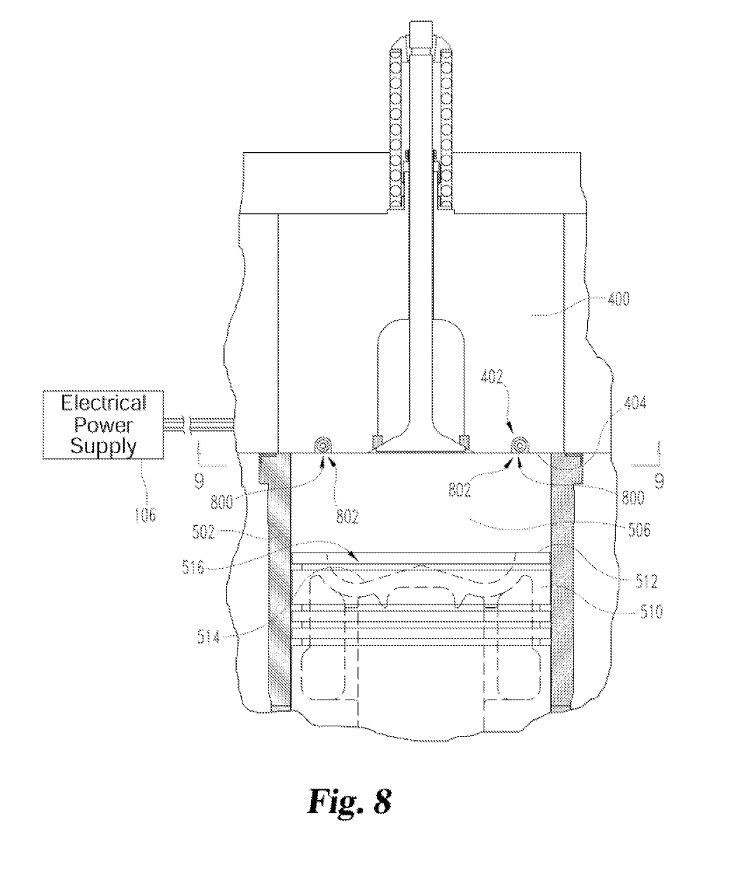

FIG. 8 illustrates another embodiment with insertable members 800 having conductive members 802 that are insertable into combustion chamber 506 through a side thereof, such as through cylinder wall 502 and/or through head 400. In some instances, conductive members 802 are insertable along a lateral direction into a recess 402 in deck 404 of cylinder head 400. Advantageously, conductive members 802 can be positioned in recess 402 and communicate with combustion chamber 506 such that high-resistance portions 804 are substantially accessible on all sides by air/fuel mixture contained within the combustion chamber 506 for ignition initiation. In engines having sufficient clearance to accommodate conductive members 802, conductive members 802 can be positioned further towards the center of combustion chamber 506, which can improve flame kernel formation and accelerate propagation through the entirety of combustion chamber 506, thus allowing a quicker and more efficient combustion.

In some instances, recess 516 defined by contour 514 of piston face 512 is arranged to receive a portion of interior portion 104 of ignition system 100, such as conductive member 802, so that when piston 510 is in the top-dead center position, interior portion 104 does not contact portions of piston 510. For example, recess 516 may be substantially the same shape as a portion of interior portion 104, such as conductive member 802. Alternatively or additionally, recess 516 defined by contour 514 may be arranged to provide for turbulence and/or swirling of the air/fuel mixture but still be capable of receiving conductive member 802. In some instances, conductive member 200 can be arranged so as to reside within recess 516.

FIG. 9 illustrates a bottom view of head 400 and insertable members 800 as viewed along line 9-9 of FIG. 8. In some embodiments, conductive members 802 are arranged for insertion and/or removal through an opening in cylinder wall 502. For example, in some instances, a conductive member 802 forms an elongated arrangement that extends substantially across the width of combustion chamber 506. Conductive members 802 may be linear and/or curvilinear. Additionally, or alternatively, conductive members 802 can be arranged to extend around the intake valve 702 and/or exhaust valve 704 for engines having such valve openings in head 400.

As illustrated in FIG. 9, conductive members 802 can be positioned on either side of the intake valve 702 and/or exhaust valve 704. At ends 900, insertable members 800 can have insulators 902 arranged to electrically insulate the inserted conductive members 802 from the cylinder wall 502 and/or head 400. In some instances, insulators 902 comprise a threaded portion arranged to engage threads of the cylinder wall 502 and/or head 400 so as to retain conductive members 802 in position within combustion chamber 506.

Ends 900 of insertable members 800 can also comprise a connector 904 arranged for electrically connecting conductive members 802 to electrical power supply 106. The electrical circuit may be completed with the opposing ends 906 connected to cylinder wall 502 and/or head 400, providing a ground, and/or with opposing ends 906 connected to each other through a permanently installed insulated coupling conductor, not shown. Advantageously, this arrangement can provide for widely spaced hot spots for rapid ignition while providing easy access for maintenance or inspection of conductive members 802.

In some embodiments, a conductive member, such as conductive member 110, 200, and/or 802 described above, extends along a path that spreads high-resistance portions of the conductive member in and/or around the combustion chamber. For example, in some embodiments, the conductive member positions a high-resistance portion substantially in the center of the combustion chamber as well as at least one high-resistance portion along the periphery of the combustion chamber. Additionally or alternatively, a conductive member may position two or more high-resistance portions between the center of the combustion chamber and the inner surface of the cylinder wall and/or the conductive member may position two or more high-resistance portions along the periphery of the combustion chamber.

A conductive member may conform around portions of the deck, such as those portions defining a valve opening. For example, the conductive member can conform around intake valve 702 and/or exhaust valve 704. This may be desired so that the conductive member does not interfere with the operation of a valve. In some embodiments, a conductive member can extend substantially along a portion of the periphery of the intake valve, exhaust valve, and/or along a portion of the inner surface of the cylinder wall.

Various arrangements of the conductive member(s) can position high-resistance portions across a wide area of the combustion chamber. Advantageously, this arrangement can provide for multi-point ignition of an air/fuel mixture contained within the combustion chamber so as to create and propagate multiple flame kernels. This can allow for substantially complete ignition of the ignitable materials within combustion chamber in a shorter period of time than compared to a single point ignition system, such as many spark ignition systems.

As will be appreciated by one of ordinary skill in the art, high-resistance portions of the conductive member(s) can be arranged so as to facilitate flame kernel formation and propagation through the combustion chamber in a particular configuration. For example, the conductive member(s) may position high-resistance portions so that multiple flame kernels form in the center of the combustion chamber and propagate towards the periphery (e.g., towards the cylinder wall) and/or vice versa. In some instances, the conductive member(s) may be arranged to form and/or propagate flame kernels from one side of combustion chamber towards another side of the combustion chamber. Still, in some embodiments, the conductive member(s) may be arranged to form and/or propagate flame kernels in a swirling and/or scooping direction. For example, the conductive member(s) may be arranged to form multiple flame kernels along a path around the combustion chamber, such as along the cylinder wall, (e.g., in a clock-wise or counter-clock-wise direction around the combustion chamber).

In some instances, configuring the conductive member(s) to form and/or propagate flame kernels in a desired configuration may be advantageous to improve the ignition of all or substantially all ignitable materials within combustion chamber. Alternatively or additionally, the conductive member(s) may be arranged so as to increase the rate of ignition of a percentage of ignitable materials (e.g., 90%). In some instances, it may be advantageous so as to improve the exhausting and/or scavenging of gases from the combustion chamber, such as in two-cycle engines. Still, in some embodiments, the conductive member(s) may be arranged so as to reduce and/or eliminates undesirable pressure waves within combustion chamber that may retard and/or inhibit flame kernel formation and propagation and/or potentially damage the engine.

In some embodiments, portions of the conductive member(s) may be arranged to form and/or propagate flame kernels at different voltages, currents, and/or frequencies of electrical energy provided by the electrical power supply. For example, in some instances, a conductive member may be arranged so that a first high-resistance portion of the conductive member is arranged to reach the combustion temperature for the air/fuel mixture after a second high-resistance portion is arranged to reach that temperature. This may allow for multi-point ignition with one point igniting the air/fuel mixture slightly before the other point. In other words, the conductive member(s) may be arranged so that separate flame kernels are created at different times along a length of the conductive member. As will apparent from the discussion below, this may be accomplished by having high-resistance portions of different arrangements, such as different shapes, dimensions, and/or materials, along the conductive member.

In some instances, the conductive member(s) may be arranged so portions initiating the flame kernel, e.g., high-resistance portions, cool at a faster rate than other portions of the conductive member, e.g., low-resistance portions. For example, a conductive member may be arranged so that after ignition has occurred and electrical power is ceased being applied to the conductive member, some portions of the conductive member may drop in temperature more rapidly than other portions. Advantageously, this can allow the hottest portions of the conductive member(s) to drop to a temperature sufficient to prevent or resist preignition.

In some embodiments, the conductive member(s) and the electrical power supply are configured and arranged to raise the temperature of the surface of the conductive member(s) at least 40° C. in less than about 2 milliseconds. Additionally or alternatively, the electrical power supply and/or conductive member(s) can be configured and arranged to allow the surface of the conductive member(s) to cool at least 80° C. in less than about 40 milliseconds or, in some instances, in less than about 20 milliseconds, and most preferably in less than about 10 milliseconds.

One of ordinary skill in the art will appreciate that one conductive member or multiple conductive members may be used to position high-resistance portions in multiple locations within the combustion chamber. Additionally or alternatively, a conductive member may position ignition initiating portions, such as high-resistance portions, in series or in parallel. Similarly, multiple conductive members may be arranged in series and/or in parallel with each conductive member having at least one high-resistance portion or multiple high-resistance portions in series and/or in parallel.

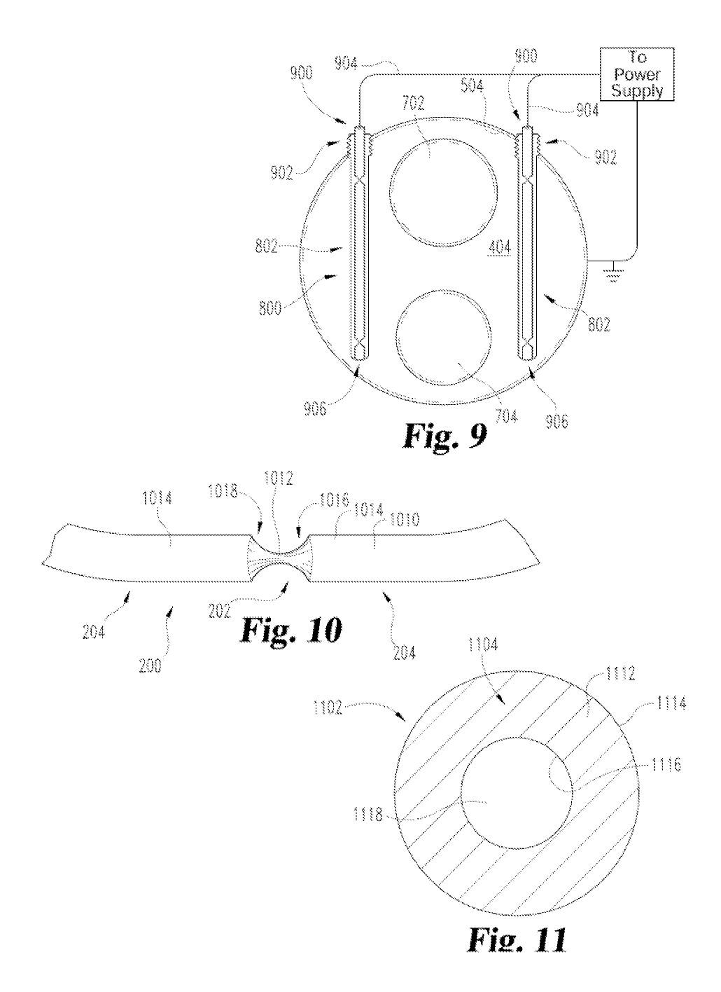

FIG. 10 illustrates one embodiment of a portion of a conductive member. For example, conductive member 200 of FIG. 10 comprises a wire 1010 with high-resistance portion 202 comprising a reduced portion 1012 and low-resistance portion 204 having large dimension portions 1014. In some instances, reduced portion 1012 and large dimension portions 1014 are coupled by a first transition 1016 and/or a second transition 1018.

As will be appreciated by one of ordinary skill in the art, high-resistance portion 202 may be arranged for a desired resistance. For example, to increase the resistance of high-resistance portion 202, the length of reduced portion 1012 extending between first transition 1016 and second transition 1018 may be increased. Alternatively or additionally, the length of first and/or second transitions 1016, 1018 may be arranged for a particular resistance.

The resistance of high-resistance portion 202 may also be configured by arranging the minimum outer dimension of reduced portion 1012, first transition 1016, and/or second transition 1018. For example, reduced portion 1012 may be arranged to have a smaller minimum outer dimension so as to increase the resistance of high-resistance portion 202.

The resistance of the high-resistance portion 202 may be arranged so that with a particular power supply, the high-resistance portion 202 can heat rapidly to a temperature above the combustion temperature of the air/fuel mixture and can cool to a temperature below the combustion temperature prior to the cylinder's next full compression of un-ignited air/fuel mixture so as to avoid pre-ignition. This can be particularly critical for engines that operate at higher rotational velocities (e.g., RPMs) and therefore have a shorter period of time between cycles.

As will be appreciated, portions of the conductive member, such as reduced portion 1012, can have a variety of shapes and dimensions. For example, first transition 1016 and/or second transition 1018 can define a substantially linear transition from large dimension portions 104 to reduced portion 1012. In some embodiments, first transition 1016 and/or second transition 1018 are adjacent to one another so as to form a ‘u’ and/or ‘v’ shaped arrangement. Similarly, first transition 1016 and/or second transition 1018 can define a concave outer surface of wire 1010.

Various cross-sectional shapes and dimensions of portions of the conductive member are also contemplated in the present disclosure. In several embodiments, portions of the conductive member have a circular cross-section. However, in some instances, portions of the conductive member may have a cross-sectional shape that resembles a polygon or another closed figure. For example, in some embodiments the low-resistance portions of the conductive member may have a rectangular shape so as to mate with a particular mount for attachment to a head of an engine. Similarly, the high-resistance portions may comprise a non-circular cross-section, such as a rectangular cross-section or an elongated cross-section pointed on each end and with curved sides, such as a lancet ogive, just to name a few non-limiting examples.

As will be appreciated by one of ordinary skill in the art, material choice may influence the cross-sectional shape of portions of the conductive member, and vice versa. For example, certain cross-sectional shapes of the high-resistance portions of the conductive member may be desired for certain materials. In particular, a high-resistance portion with a circular cross-sectional shape may be preferred for magnetic materials while an elongated cross-sectional shape may be preferred for non-magnetic materials. Similarly, some shapes may be preferred for materials exhibiting a high resistance to fouling while other shapes are preferred for materials exhibiting a low resistance to fouling.

In some embodiments, a high-resistance portion comprises a section, such as reduced portion 1012, having a minimum outer dimension less than that of a low-resistance portion, such as large dimension portion 1014. In some instances, a high-resistance portion has a minimum outer dimension that is less than ⅓ the minimum outer dimension of said low-resistance portion. For example, in some embodiments, a conductive member comprises a high-resistance portion that has a reduced portion 1012 with a minimum outer dimension of less than about 0.04 inches and a low-resistance portion with a minimum outer dimension of about one tenth of an inch.

The conductive member may be constructed from a number of electrically conductive materials. For example, the major portion of the conductive member may comprises one or more elements of the group consisting of aluminum, chromium, copper, iridium, iron, molybdenum, nickel, palladium, platinum, rhodium, and titanium. Stainless steel or nichrome, can specifically be considered, just to name a few non-limiting examples. In some embodiments, it is preferred that portions of the conductive member be comprised of materials arranged to increase the skin effect at certain frequencies. For example, the conductive member may comprise a material with a relatively high magnetic permeability. For instance, high-resistance portions of the conductive member may comprise a material with a maximum magnetic permeability of at least 1×10⁻⁵ H/m or, in some cases, at least 1×10⁻⁴ H/m. Similarly, in some embodiments, portions of the conductive member can comprise a material exhibiting a low electrical resistivity, such as material having an electrical resistivity of less than 1×10⁻⁶ Ωm at 20° C. or, in some instances, less than 1×10⁻⁷ Ωm at 20° C.

Portions of the conductive member, such as the high-resistance portions and the low-resistance portions, can comprise different materials. For example, in some instances, a high-resistance portion of a conductive member may comprise a material having an electrical conductivity and/or a magnetic permeability that promotes the skin effect, such as for example, stainless steel or nichrome, while the low-resistance portion comprises a material that has a greater skin depth for given frequencies, such as for example, copper or aluminum. For example, in some embodiments, reduced portion 1012 comprises a material that exhibits high resistance to high frequency AC/DC and/or large dimension portion 1014 comprises a material that exhibits low resistance to high frequency AC/DC. In configurations in which high-frequency AC current flows through wire 1010, reduced portion 1012 may comprise a material having a low electrical resistivity and/or a high absolute magnetic permeability so as to decrease the skin depth and increase the resistance of reduced portion 1012 at high frequencies. Additionally or alternatively, large dimension portion 1014 of wire 1010 may comprise a material arranged to remove heat from reduced portion 1012, so as to decrease the temperature of reduced portion 1012, such as material having a high thermal conductivity.

In some instances, portions of the conductive member comprise a material having a relatively high thermal conductivity. For example, in some embodiments, high-resistance portions of the conductive member comprise a material having a thermal conductivity of at least 10 W/(mK) or, in some cases, at least 100 W/(mK). Advantageously, materials having a high thermal conductivity can more rapidly remove heat from the skin of the reduced portion and/or from the reduced portion itself. The different portions can be layered with different materials in each layer to optimize the desired effects.

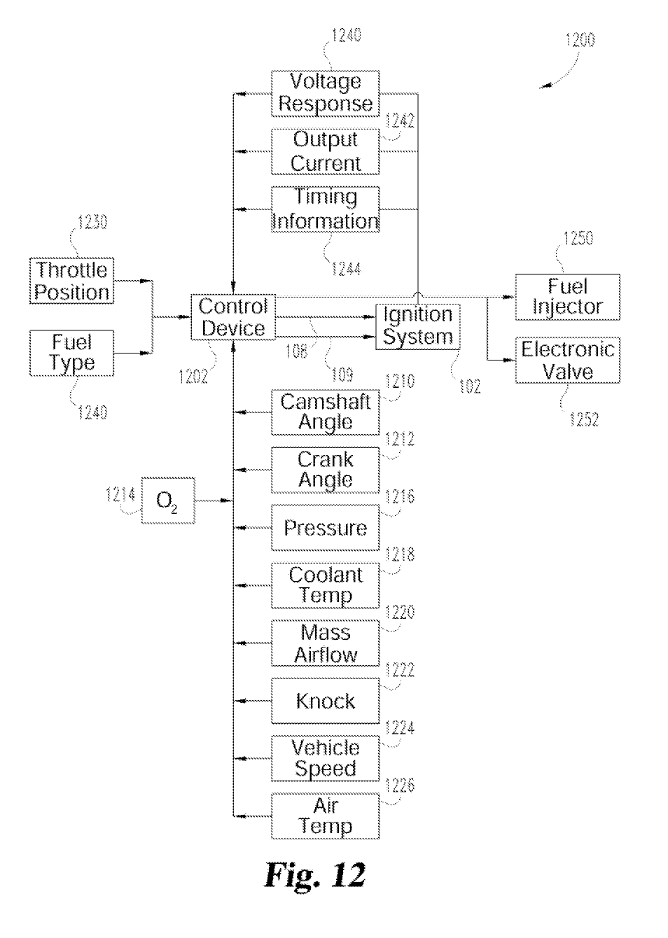

FIG. 11 illustrates a cross-sectional view of a portion of one embodiment of a conductive member. In some instances, the conductive member has an outer portion 1102 and an inner portion 1104. Outer portion 1102 can be arranged to heat under high-frequency AC and/or DC electrical energy with inner portion 1104 arranged to remove heat from the outer portion 1102. For example, a high-resistance portion of the conductive member can comprise a wall portion 1112 having an outer surface 1114 and an inner surface 1116. Inner surface 1116, which may be coated with a thin layer of an electrical insulator, defines a cavity 1118 that may be arranged to receive a working fluid, such as a thermally-conductive fluid, for transferring heat from inner surface 1116 of wall portion 1112 to the fluid positioned within cavity 1118, so as to remove heat from wall portion 1112.

In some instances, the working fluid positioned within cavity 1118 may comprise a flowable material such as a liquid. For example, the flowable fluid may comprise a coolant for the internal combustion engine and/or a separate cooling fluid. For special applications, the flowable fluid positioned within cavity 1118 may even comprise a liquid metal, such as liquid sodium for cooling inner surface 1116 to thereby cool wall portion 1112 and in turn by conduction through wall portion 112, outer surface 1114, provided suitable precautions are taken into account to address the general reactivity of the hot metal when exposed to water or the atmosphere.

In some embodiments, the inner portion 1104 can comprise a heat pipe. For example, high-resistance portion of the conductive member may heat a liquid positioned within cavity 1118 so as to change the liquid into a vapor. The vapor can then travel through cavity 1118 along a length of conductive member. When the vapor reaches a cooler portion of inner surface 1116, such as a low-resistance portion or a portion outside of the combustion chamber, the vapor can condense back into a liquid, releasing the latent heat, and the liquid flow back to the high-resistance portion such as by the force of gravity. The liquid may then be evaporated once more and the repeat the cycle. As will be appreciated, other devices and systems may also be used to transfer heat from the high-resistance portion of the conductive member such as thermosiphons and thermal diodes, to name a few non-limiting examples.

In some instances, portions of the conductive member may comprise a coating on outer surface 1114 and/or the inner surface 1116. For example, a low-resistance portion such as large dimension portion 1014 of wire 1010 may comprise and outer coating arranged to reduce heat transfer from the combusted gas within the combustion chamber of the engine into large dimension portion 1014 of wire 1010. Additionally or alternatively, reduced portion 1012 of wire 1010 may comprise outer coating arranged to increase heat transfer from wire 1010 to an air/fuel mixture positioned within the combustion chamber. For example in some instances, the outer coating may be a metal configured to decrease the resistance of reduced portion 1012 of wire 1010 so as to increase the skin effect and increased the temperature of reduced portion 1012 when electricity flows through wire 1010 at a high frequency.

Similarly, in some instances, wire 1010 may comprise an interior coating that can be arranged to increase and/or decrease heat transfer from inner surface 1116 of wall portion 1112 to a working fluid positioned within cavity 1118. For example, reduced portion 1012 of wire 1010 may have an interior coating on inner surface 1116 that is arranged to increase heat transfer from wall portion 1112 to the working fluid, so as to remove heat from wall portion 1112 and reduce the temperature of outer surface 1114.

In some instances, inner surface 1116 of wall portion 1112 and/or an interior coating may be arranged to increase heat transfer from wall portion 1112 to a working fluid positioned within cavity 1118. For example, inner surface 1116 of wall portion 1112 may comprise fins and/or a rough surface arranged to increase the surface area of wall portion 1112 contacting the working fluid within cavity 1118.

### Method of Use

Prior to the combustion stroke in reciprocal engines, e.g., two-cycle and four-cycle engines, the piston is traveling from the bottom-dead position towards the top-dead position. As the piston reaches the top-dead center position, electrical energy may be applied to the conductive member positioned within the combustion chamber of the engine so as to increase the temperature of portions of the conductive member, such as high-resistance portion 202, to a temperature approaching the combustion temperature of the air/fuel mixture to be combusted within the combustion chamber. In some instances, application of electrical energy, such as alternating current or direct current pulses, to the conductive member may be configured so as to increase the temperature of a surface of the conductive member to at least the combustion temperature just prior to and/or when the piston reaches the top-dead center within the chamber.

In some instances, it is possible to cease applying electrical energy to the conductive member prior to ignition. For example, high-resistance portion 202 of conductive member 200 may heat to a temperature below that of the ignition temperature of the air/fuel mixture within combustion chamber before the piston reaches top dead center. In this instance, high-resistance portion 202 heats a portion of air and/or air/fuel mixture within the combustion chamber to a temperature at which the remaining compression and/or injection of fuel into the cylinder will cause the air and/or air/fuel mixture within the combustion chamber to reach and/or exceed a temperature sufficient to cause ignition. In some embodiments, it is preferable to stop and/or reduce the amount of electrical energy applied to the conductive member early, so as to reduce excess heat that must be removed from high-resistance portions and/or low-resistance portions of the conductive member prior to the next combustion cycle.

Alternatively, it may be desirable to continue supplying electrical energy to the conductive member after ignition has begun. For example, it may be preferred that surface portions of the conductive member remain above the combustion temperature of the air/fuel mixture positioned within the combustion chamber so as to ignite remaining un-ignited combustible materials during the combustion stoke and or to achieve and/or maintain a sufficiently high temperature for emission control. For example, achieving and/or maintaining a desired temperature within the combustion chamber may be preferred so as to minimize the production of certain harmful byproducts.

After the combustion phase of a reciprocal engine, the piston moves from the bottom-dead center position towards the top-dead center position so as to exhaust the ignited air/fuel mixture from the combustion chamber and/or intake new air or air/fuel mixture. During this stroke and/or subsequent strokes it is preferable that the surface temperature of the conductive member fall to a temperature sufficient to prevent pre-ignition in engines compressing an already mixed air/fuel mixture. For example, it may be preferable that the surface temperature of the high-resistance portions 202 of conductive member 200 fall below the combustion temperature prior to the intake of the new air/fuel mixture. Additionally or alternatively, it may be preferable that the temperature of the conductive member fall to a temperature below that sufficient to ignite an air/fuel mixture within the combustion chamber prior to the piston fully compressing the un-ignited air/fuel mixture.

### Controls

FIG. 12 is a flowchart 1200 illustrating one method of controlling an ignition system, such as those illustrated above. Generally, the control system comprises a control device 1202, such as an engine control unit (ECU). The control device 1202 is arranged to provide a signal to a portion of the ignition system 100 to trigger the electrical power supply 106 to supply electrical power to the interior portion 104 of the ignition system 100, such as conductive member 110 or 200. Preferably, control device 1202 automatically adjusts the electrical power supply in response to at least one engine sensor, such as one selected from the group consisting of a conductive member temperature sensor and/or an ignition sensor (not illustrated in FIG. 12).

Control device 1202 can also be arranged to receive a plurality of signals and adjust the performance of the internal combustion engine 1000 based on those signals and calculations therefrom. For example, control device 1202 may receive signals form a plurality of sensors positioned in or around the engine. In some embodiments, control device 1202 may receive a signal from a camshaft position sensor 1210, a crankshaft position sensor 1212, an oxygen sensor 1214, a pressure sensor 1216 such as a manifold pressure sensor, a coolant temperature sensor 1218, a mass airflow sensor 1220, a piezoelectric/knock sensor 1222, a vehicle speed sensor 1224, and/or a signal from an air temperature sensor 1226. Similarly, control device 1202 can be arranged to receive a plurality of signals from an operator of the engine or a vehicle comprising the engine. For example, a signal from a throttle position sensor 1230 and/or a signal from a fuel type switch 1232 may be provided to control device 1202.

Control device 1202 may receive at least one signal from the ignition system. For example, control device 1202 may receive a voltage response signal 1240, an output current signal 1242, and/or a timing signal 1244 from ignition system 100. These signals may be used to determine a condition of ignition system 100 and/or a condition within a cylinder of the engine. For example, signals 1240, 1242, and/or 1244 may be used to calculate the temperature of a high-resistance portion 202 within the combustion chamber of the engine. For example, the control device can calculate the effective resistance of a high-resistance portion of the ignition system, such as by dividing the voltage by the current, and then compare the effective resistance to known values of resistance at certain temperatures. In some instances, control device will compare the effective resistance values to a table or it may enter the resistive value into an equation to estimate the temperature of a high resistance portion. Examples of engine sensors to monitor the conductive member temperature sensor can include those that sense voltage and/or current associated with the conductive member, as well as the use of a thermocouple placed adjacent the conductive member, or the use of an optic sensor to sense infrared or visible changes associated with changes in temperature.

Control device 1202 may also use signals 1240, 1242, and/or 1244 to detect a failure of ignition system 100. For instance, control device 1202 may detect an open circuit condition and/or a short of the conductive member and or the electrical power supply. Control device 1202 may also detect the remaining life of a conductive member by comparing the signals 1240, 1242, and/or 1244 to known responses.

Additionally or alternatively, control device 1202 may use one or more signals 1240, 1242, and/or 1244 to adjust the signal provided by control device 1202 to the ignition system 100. For example, voltage response signal 1240, output current signal 1242, and/or a timing signal 1244 from the ignition system 100 may be used to calculate the time it takes for a portion of a conductive member to reach the combustion temperature after electrical energy is first supplied by electrical power supply 106. This time may then be used to adjust the time when the control device 1202 should signal the ignition system 100 to provide electrical power.

Control device 1202 may use signals 1240, 1242 and/or 1244 and/or signals from one or more of the sensors described above to adjust the frequency, voltage, current, and/or duty cycle of the electrical power being supplied. For example, if control device 1202 detects a misfire, such as by piezoelectric/knock sensor 1216 failing to detect a vibration indicative of ignition or by control device 1202 detecting an abnormally low temperature within the cylinder, control device 1202 may automatically increase the frequency, voltage, current, and/or duty cycle of the electrical power being supplied to the conductive member within the combustion cylinder so as to achieve combustion in a subsequent cycle. Similarly, if control device 1202 detects preignition or an undesirably high temperature of conductive member, control device 1202 may automatically reduce the frequency, voltage, current, and/or duty cycle of the electrical power being supplied so as to reduce the likelihood of preignition and/or premature failure of conductive member, just to name a few examples. Various examples of ways that one could implement an ignition sensor would include inductive, capacitive, resistive, piezoelectric, Hall effect, and optic sensors as are known for sensing vibration, motion and/or sound generally.

As will be appreciated, control device 1202 can use the above signals and/or combinations thereof to adjust various controls in or around the engine and to adjust the operation of ignition system 100. For example, control device 1202 may send a signal to a fuel injector 1250 and/or an electronic valve 1252 such as an air control valve or an intake and/or exhaust valve of a cylinder of the engine. Alternatively or additionally, control device 1202 may adjust the voltage and/or frequency of electrical energy supplied by electrical power supply 106 and/or the timing when such electrical energy is supplied.

While at least one embodiment has been illustrated and described in detail in the drawings and foregoing description, the same is to be considered as illustrative and not restrictive in character, it being understood that the preferred embodiment has been shown and described and that all changes, equivalents, and modifications that come within the spirit of the inventions defined by following claims are desired to be protected. It will be evident from the specification that aspects or features discussed in one context or embodiment will be applicable in other contexts or embodiments. All publications, patents, and patent applications cited in this specification are herein incorporated by reference as if each individual publication, patent, or patent application were specifically and individually indicated to be incorporated by reference and set forth in its entirety herein.

1. An internal combustion engine powered by a fuel with an ignition point above 400° C., comprising:
A combustion chamber in an internal combustion engine;
a conductive member having a portion positioned inside said combustion chamber arranged to provide ignition of a fuel having an ignition point above 400° C.; and
an electrical power supply configured and arranged to periodically provide electrical power at a frequency above 100 kHz to said conductive member portion sufficient to raise the temperature of the outer surface of said conductive member portion above 400° C., whereby the engine can operate with a fuel having an ignition point above 400° C.

2. The engine of claim 1, wherein the internal combustion engine is a reciprocating engine.

3. The engine of claim 1, wherein the internal combustion engine is a two-cycle engine.

4. The engine of claim 1 additionally comprising a supply of fuel, wherein the fuel is selected from the group consisting of ethanol, propane, and natural gas.

5. The engine of claim 4 wherein the fuel is natural gas.

6. The engine of claim 1, wherein said electrical power supply and conductive member are configured and arranged to raise the temperature of the conductive member at least 40° C. in less than about 2 milliseconds.

7. The engine of claim 1, wherein said conductive member is configured and arranged to cool to a temperature sufficient to prevent pre-ignition.

8. The engine of claim 1, wherein said conductive member is configured and arranged to cool at least 80° C. in less than about 40 milliseconds.

9. The engine claim 8, wherein said conductive member is configured and arranged to cool at least 80° C. in less than about 10 milliseconds.

10. The engine of claim 1, wherein said electrical power supply is configured and arranged to provide an alternating current.

11. The engine of claim 10 wherein said electrical power supply is configured and arranged to provide an alternating current at a frequency above 100 kHz.

12. The engine of claim 11, wherein said electrical power supply provides electrical power at a frequency below 200 MHz.

13. The engine of claim 1, wherein said conductive member comprises a material having a maximum magnetic permeability of at least 1×10⁻⁵ H/m.

14. The engine of claim 13, wherein said conductive member comprises a material having a maximum magnetic permeability of at least 1×10⁻⁴ H/m.

15. The engine of claim 1, wherein said thermal conductor comprises a metal.

16. The engine of claim 15, wherein said conductive member comprises a metal, the majority portion of which comprises one or more elements of the group consisting of aluminum, chromium, copper, iridium, iron, molybdenum, nickel, palladium, platinum, rhodium, and titanium.

17. The engine of claim 16 wherein the conductive member comprises a metal selected from one or more elements of the group consisting of chromium, iron, and nickel.

18. The engine of claim 17 wherein the conductive member comprises stainless steel.

19. The engine of claim 17 wherein the conductive member is nichrome.

20. A two-cycle internal combustion engine, comprising:
a conductive member having a portion positioned inside a combustion chamber of the internal combustion engine and arranged to provide ignition of a fuel; and
an electrical power supply configured and arranged to periodically provide electrical power at a frequency above 100 kHz to said conductive member portion sufficient to raise the temperature of the outer surface of said conductive member portion above the ignition temperature of the fuel.

21. The engine of claim 20 which additionally comprises a source of fuel and wherein the fuel is selected from the group consisting of ethanol, propane, and natural gas.

22. The engine of claim 20, wherein said electrical power supply and conductive member are configured and arranged to raise the temperature of the conductive member at least 40° C. in less than about 2 milliseconds.

23. The engine of claim 20, wherein said conductive member is configured and arranged to cool to a temperature sufficient to prevent pre-ignition.

24. The engine of claim 20, wherein said conductive member is configured and arranged to cool at least 80° C. in less than about 40 milliseconds.

25. The engine of claim 24, wherein said conductive member is configured and arranged to cool at least 80° C. in less than about 10 milliseconds.

26. The engine of claim 20, wherein said electrical power supply provides electrical power at a frequency below 200 MHz.

27. The engine of claim 20, wherein said conductive member comprises a material having a maximum magnetic permeability of at least 1×10⁻⁵ H/m.

28. The engine of claim 27, wherein said conductive member comprises a material having a maximum magnetic permeability of at least 1×10⁻⁴ H/m.

29. The engine of claim 25, wherein said conductive member comprises a metal, the major portion of which comprises one or more elements of the group consisting of aluminum, chromium, copper, iridium, iron, molybdenum, nickel, palladium, platinum, rhodium, and titanium.

30. An internal combustion engine, comprising:
a conductive member having a portion positioned inside a combustion chamber of the internal combustion engine and arranged to provide ignition of a fuel;
an electrical power supply configured and arranged to periodically provide electrical power at a frequency above 100 kHz to said conductive member portion sufficient to raise the temperature of the outer surface of said conductive member portion above the ignition temperature of the fuel; and
a control unit to automatically adjust said electrical power supply in response to at least one engine sensor selected from the group consisting of a conductive member temperature sensor and an ignition sensor.

31. The engine of claim 30 in which said at least one engine sensor is an ignition sensor selected from the group consisting of an inductive, a capacitive, resistive, piezoelectric, hall effect, and optic sensor.

32. The engine of claim 31 in which said ignition sensor is a piezoelectric sensor for automatically adjusting power to said conductive member.

33. The engine of claim 30 in which said at least one engine sensor is a conductive member temperature sensor selected from the group consisting of a voltage, current, thermocouple, or optic sensor.

34. The engine of claim 33 in which said conductive member temperature sensor is a current sensor that determines temperature inferentially by measuring the current flowing through said conductive member portion for automatically adjusting power to said conductive member.

35. An ignition apparatus for an internal combustion engine, comprising:
an electrical power supply;
a conductive member having a portion arranged for positioning inside a combustion chamber of the internal combustion engine;
said conductive member comprising at least two high-resistance portions separated by a low-resistance portion that spaces said two high-resistance portions apart within the combustion chamber; and
said conductive member connected to said electrical power supply through a conductor arranged to pass from one of said high resistance portions to a point outside of the combustion chamber.

36. The conductive member of claim 35, wherein said high-resistance portions comprise a metal, the major portion of which comprises one or more elements of the group consisting of chromium, iridium, iron, molybdenum, nickel, palladium, platinum, rhodium, and titanium.

37. The conductive member of claim 35, wherein said high-resistance portions comprise a material having a maximum magnetic permeability of at least 1×10⁻⁵ H/m.

38. The conductive member of claim 37, wherein said high-resistance portions comprise a material having a maximum magnetic permeability of at least 1×10⁻⁴ H/m.

39. The conductive member of claim 35, wherein said low-resistance portion comprises a metal, the major portion of which comprises an element selected from the group consisting of copper, aluminum, steel, and stainless steel.

40. The conductive member of claim 35, wherein said low-resistance portion comprises a material with a thermal conductivity of at least 10 W/(mK).

41. The conductive member of claim 35, wherein said low-resistance portion comprises a material with a thermal conductivity of at least 100 W/(mK).

42. The ignition apparatus of claim 35, wherein at least one of said high-resistance portions comprises a section of said conductive member having a minimum outer dimension less than that of said low-resistance portion.

43. The ignition apparatus of claim 42, wherein at least one of said high-resistance portions has a minimum outer dimension that is less than ⅓ the minimum outer dimension of said low-resistance portion.

44. The ignition apparatus of claim 42, wherein at least of one of said high-resistance portions has a minimum outer dimension of less than 0.04 inches.

45. The ignition apparatus of claim 35, wherein said conductive member comprises at least three high-resistance portions separated by low resistance portions.

46. The ignition apparatus of claim 35, wherein said conductive member comprises at least four high-resistance portions separated by low-resistance portions.

47. The conductive member of claim 46, wherein said high-resistance portions are arranged in series.

48. The ignition apparatus of claim 35, wherein said electrical power supply is configured and arranged to supply alternating current.

49. The ignition apparatus of claim 49, wherein said electrical power supply is configured and arranged to supply electrical power at a frequency above 100 kHz.

50. The ignition apparatus of claim 49, wherein said electrical power supply is configured and arranged to supply electrical power at a frequency below 200 MHz.

51. An internal combustion engine comprising:
an internal combustion engine having at least one cylinder formed from a block and a head,
an electrical power supply configured and arranged to periodically provide electrical power at a frequency above 100 kHz;
a first conductive member and a separate second conductive member separately spaced from said first conductive member and each comprising a high-resistance portion located within the same cylinder of the internal combustion engine; and
said conductive members electrically connected to said electrical power supply.

52. The engine of claim 51, wherein said first and second conductive members are separately insertable and removable from the engine without removing the head of the engine from the block of the engine.

53. The engine of claim 51, wherein said first and second conductive members are recessed within the head of said engine.

54. The engine of claim 51, wherein at least one of said first or second conductive members further comprises a second said high-resistance portion separated from said first high-resistance portion by a low-resistance portion.

55. An internal combustion engine, comprising:
a conductive member portion positioned inside a combustion chamber of the internal combustion engine to provide ignition of an air/fuel mixture and comprising an inner portion and an outer portion;
said inner portion comprising a thermal conductor thermally coupled to said outer portion and arranged to remove heat from said outer portion; and
an electrical power supply configured and arranged to periodically provide electrical power at a frequency above 100 kHz to said conductive member portion in sufficient quantity to raise the temperature of said outer portion sufficient for ignition.

56. The engine of claim 55, wherein said inner portion comprises a material with a thermal conductivity of at least 10 W/(mK).

57. The engine of claim 55, wherein said inner portion comprises a material with a thermal conductivity of at least 100 W/(mK).

58. The engine of claim 55, wherein said thermal conductor comprises a fluid.
